(19) United States
(12) Patent Application Publication
(10) Pub. No.: US 2022/0242023 A1
(43) Pub. Date: Aug. 4, 2022

(54) METHOD FOR MEASURING FLUIDITY INDEX OF MOLTEN RESIN

(71) Applicant: TOSHIBA KIKAI KABUSHIKI KAISHA, Tokyo (JP)

(72) Inventor: Hiroshi OKUYAMA, Shizuoka-ken (JP)

(73) Assignee: SHIBAURA MACHINE CO., LTD., Tokyo-to (JP)

(21) Appl. No.: 17/612,890

(22) PCT Filed: Feb. 4, 2020
(86) PCT No.: PCT/JP2020/004072

§ 371 Date: Nov. 19, 2021

(30) Foreign Application Priority Data
May 21, 2019 (JP) 2019-095406

(51) Int. Cl. B29C 45/77; B29C 45/18; B29C 45/17

(52) U.S. Cl. CPC B29C 45/77; B29C 45/1808; B29C 2945/76367; B29C 2945/76006; B29C 45/1735

(57) ABSTRACT

There is provided a molten resin fluidity index measuring method which can detect the fluidity of a molten resin online even during successive molding operations. The method includes: assuming that a narrow flow path, formed in a flow path for the molten resin, is a capillary or an orifice in a metering step in which the molten resin is collected in front of the screw; measuring, with an injection apparatus of the injection molding machine, the amount of the metered resin and the back pressure applied to the screw during the metering step; and calculating, based on the amount of the metered resin and the back pressure, a fluidity index which indicates the fluidity properties of the metered molten resin.

### TECHNICAL FIELD

The present invention relates to a method for measuring a fluidity index of a molten resin.

### BACKGROUND ART

In an injection molding machine, a resin as a molding material, fed into a heating barrel, is plasticized by rotating a screw. The molten resin is conveyed to an area in front of the screw and metered there while moving the screw backward. In an injection step, the screw is moved forward to fill the molten resin into a mold.

How to handle a flowing molten resin is of essential significance in injection molding. Therefore, in order to obtain a high-quality molded product, it is important to detect and assess the fluidity of a molten resin. The fluidity of a molten resin is generally expressed in terms of the viscosity.

To measure the viscosity of a molten resin in a heating barrel is difficult as compared to the measurement of the temperature or the pressure; therefore, the measurement of the viscosity has often not been performed. However, these days there are improved techniques for measuring the viscosity of a molten resin.

For example, patent document 1 describes a technique which involves injecting a molten resin when a nozzle is not in touch with a mold in a step different from a molding step, and calculating the viscosity of the molten resin from the injection pressure.

Patent document 2 describes a technique which involves determining the pressure of a molten resin and the flow rate of the resin in a resin flow path in every injection operation to calculate the viscosity of the resin. This technique enables real-time online measurement of the viscosity of the molten resin during molding.

Patent document 3 describes a technique which involves measuring the pressure of a molten resin at the front end of a nozzle in an injecting step, and calculating the viscosity of the molten resin based on the pressure.

Citation List

Patent Literature

Patent document 1: Japanese Patent Laid-Open Publication No. 2004-142204

Patent document 2: Japanese Patent Laid-Open Publication No. H5-329864

Patent document 3: Japanese Patent Laid-Open Publication No. H11-10693

### SUMMARY OF THE INVENTION

Problems to be Solved by the Invention

The method disclosed in patent document 1, which involves purging a molten resin from the nozzle when it is separated from the mold in order to measure the viscosity of the molten resin in a step different from a molding step, has the following problems. The purging operation needs to be repeated a plurality of times in order to obtain a reliable viscosity value, resulting in disposal of a large amount of the resin. Furthermore, the fluidity of the resin cannot be detected during successive molding operations.

On the other hand, in the case of determining the viscosity of a molten resin in an injection step as described in patent documents 2 and 3, the viscosity of the molten resin cannot be determined unless it is injected into a mold. The properties of a resin material, which is provided in the form of pellets by a manufacturer, may vary among different production lots. Thus, the fluidity of a molten resin may vary among different lots of the same product. If, for some reason, an abnormality exits in the fluidity of a resin, the abnormality cannot be detected in a metering step.

The present invention has been made in view of the above problems in the prior art. It is therefore an object of the present invention to provide a molten resin fluidity index measuring method which can detect the fluidity of a molten resin online even during successive molding operations.

Means for Solving the Problems

In order to achieve the object, the present invention, in one embodiment, provides a method for measuring a fluidity index of a molten resin in an injection molding machine which injects the molten resin in a heating barrel from a nozzle into a mold by means of a screw moving forward in the heating barrel, the method comprising: assuming that a narrow flow path, formed in a flow path for the molten resin, is a capillary or an orifice in a metering step in which the molten resin is collected in front of the screw; measuring, with an injection apparatus of the injection molding machine, the amount of the metered resin and the back pressure applied to the screw during the metering step;

and calculating, based on the amount of the metered resin and the back pressure, a fluidity index which indicates the fluidity properties of the metered molten resin.

### BRIEF DESCRIPTION OF THE DRAWINGS

FIG. 1 is a cross-sectional view of an injection apparatus of an injection molding machine for performing a molten resin fluidity index measuring method according to an embodiment of the present invention.

FIG. 2 is a vertical cross-sectional view of a heating barrel.

FIG. 3 is a cross-sectional view showing a non-return check ring provided at the front end of a screw.

FIG. 4 is a schematic view of a cylinder for use in the capillary rheometer method.

FIG. 5 is a block diagram of a molten resin fluidity index measuring section incorporated in a control system of the injection apparatus.

### BEST MODE FOR CARRYING OUT THE INVENTION

Embodiments of a molten resin fluidity index measuring method according to the present invention will now be described with reference to the attached drawings.

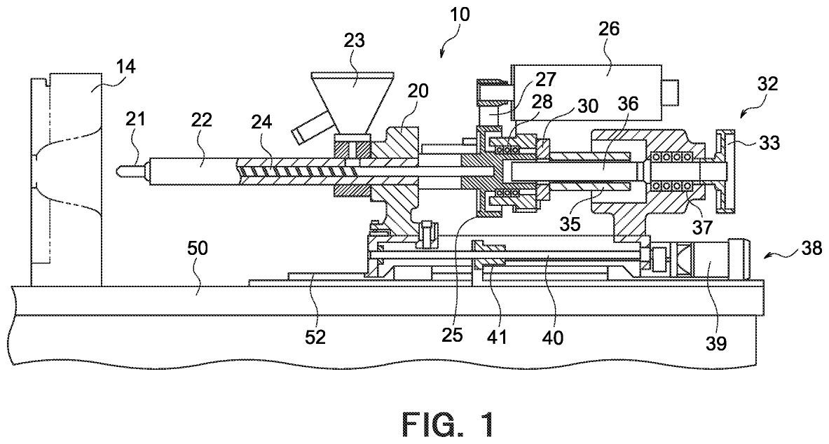

FIG. 1 is a cross-sectional view of an injection apparatus of an injection molding machine for performing a molten resin fluidity index measuring method according to an embodiment.

In FIG. 1, reference numeral 10 denotes an injection apparatus provided on a base 50. The injection apparatus 10 is installed on the base 50 movably along a rail 52. A fixed die plate 14 of a mold clamping apparatus is provided in front of the injection apparatus 10. The injection apparatus 10 includes a heating barrel 22 supported horizontally by a frame 20, and a screw 24 provided within the heating barrel 22. A nozzle 21, which is to be connected to a mold, is provided at the front end of the heating barrel 22. A hopper 23, into which resin pellets as a molding material are to be fed, is provided on the base-end side of the heating barrel 22.

The screw 24 is slidably and rotatably housed in the heating barrel 22. The base end of the screw 24 is coupled to a pulley 25 of a rotary drive mechanism. The rotary drive mechanism is configured to transmit the rotation of a screw rotating motor 26 to the pulley 25 via a transmission belt 27. A load cell 30 is provided behind a bearing 28 that supports the pulley 25. The load cell 30 is a load measuring device for measuring an axial load applied to the screw 24.

The screw 24 is configured to axially move back and forth in the heating barrel 22 by means of a back-and-forth movement mechanism 32. The back-and-forth movement mechanism 32 includes a pulley 33, to which the rotation of a not-shown back-and-forth movement motor is transmitted via a belt, a nut portion 35, a ball screw 36, a bearing 37 that supports the ball screw 36, etc.

Referring to FIG. 1, a thrust mechanism 38, which moves the entire injection apparatus 10 back and forth, is provided on the base 50. The thrust mechanism 38 includes a thrust motor 39, and a ball screw mechanism composed of a ball screw 40 and a nut 41.

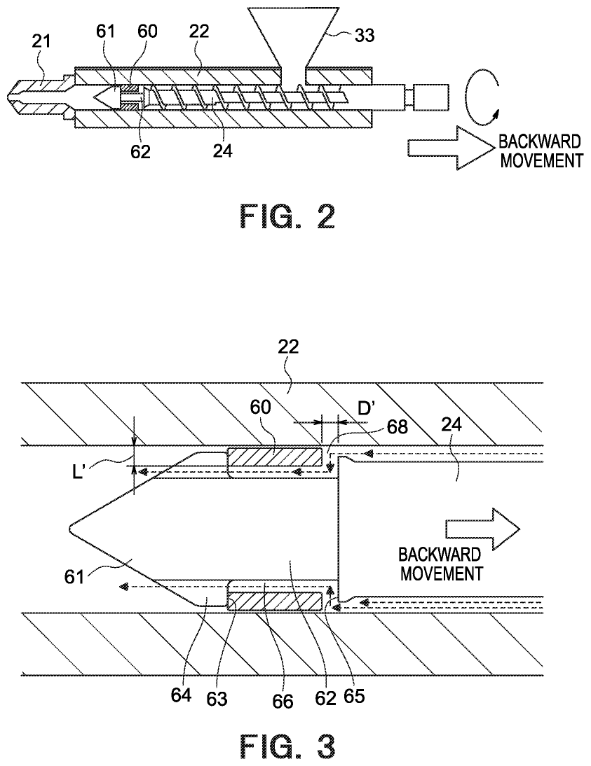

FIG. 2 shows a vertical cross-sectional view of the heating barrel 22, and FIG. 3 shows a non-return check ring 60 provided at the front end of the screw 24.

As shown in FIGS. 2 and 3, a screw tip 61 is mounted to the front end of the screw 24. The screw tip 61 is secured to the front end of the screw 24 via a small-diameter shaft 62. The screw tip 61 has a conical shape. A first flow path 64, in which a molten resin flows, is formed between the peripheral surface of the screw tip 61 and the inner peripheral surface of the heating barrel 22. The check ring 60 is axially movably mounted on the small-diameter shaft 62.

The check ring 60 is disposed between the rear end surface 63 of the screw tip 61 and a seat 65 provided at the front end of the screw 24. A second flow path 66, in which a molten resin flows and which communicates with the first flow path 64, is formed between the inner peripheral surface of the check ring 60 and the peripheral surface of the small-diameter shaft 62. FIG. 3 shows the position of the check ring 60 during a metering step. While the screw 24 is rotating to covey a molten resin forward, the screw 24 moves backward when the molten resin is metered.

The flow of a molten resin upon its metering is shown by the dotted arrows in FIG. 3. As the screw 24 moves backward upon metering of the resin, the check ring 60 relatively moves toward the screw tip 61 and away from the seat 65. The molten resin flows from a narrow flow path 68 into the second flow path 66, and flows through the first flow path 64 and is collected in front of the screw tip 61.

When injecting the molten resin, the rear end surface of the check ring 60 is pressed against the seat 65, whereby the narrow flow path 68 is closed; therefore, backward flow of the molten resin is prevented.

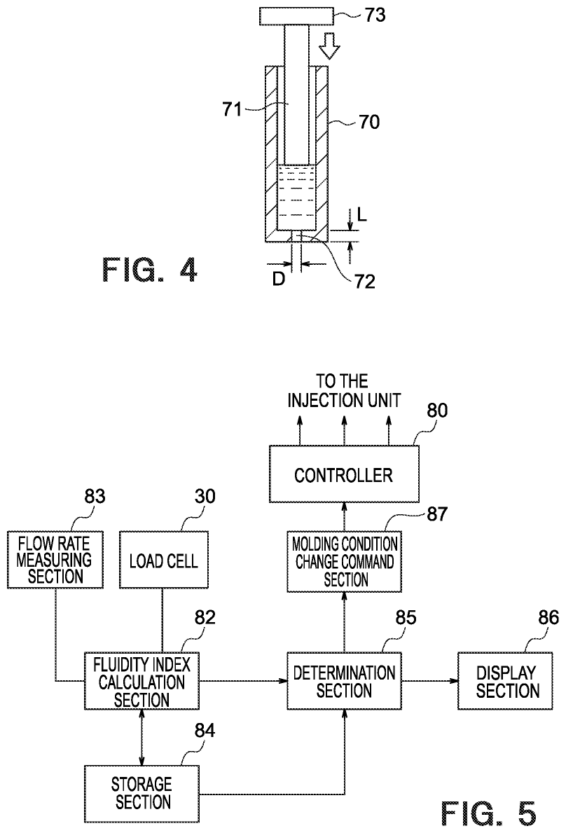

In the molten resin fluidity index measuring method of this embodiment, a fluidity index of a molten resin is calculated using the narrow flow path 68, which is formed behind the check ring 60 during a metering step, and the second flow path 66. Before describing the index measuring method, the capillary rheometer method, which is a common fluid viscosity test method, will be described with reference to FIG. 4.

FIG. 4 is a schematic view of a cylinder for use in the capillary rheometer method.

In FIG. 4, 70 denotes a cylinder, and 71 denotes a piston that fits into the cylinder 70. A capillary 72 is provided at the front end of the cylinder 70.

The capillary rheometer method comprises forcing a molten resin in the cylinder 70 out of the capillary 72 with the piston 71 moving at a constant speed, measuring the load applied to the moving piston 71 with a load cell 73, and calculating the viscosity of the fluid using the following formulae (1) to (4). The viscosity is finally calculated by the formula (4).

$$\begin{matrix}Q = Av & ( 1 ) \\ γ = 32 Q / π {D}^{3} & ( 2 ) \\ τ = p D / 4 L & ( 3 ) \\ η = τ / γ & ( 4 )\end{matrix}$$

where Q: flow rate of molten resin (mm³/s)

A: cross-sectional area of piston (mm²)

ν: speed of piston (mm/s)

γ: apparent shear rate (s⁻¹)

D: diameter of capillary (mm)

τ: apparent shear stress (Pa)

p: piston load (Pa)

L: length of capillary (mm)

η: melt viscosity (Pa·s)

Assume that referring to FIG. 4, the fluid whose viscosity is to be measured is a molten resin. The situation where the molten resin is forced out by the piston 71 in the method shown in FIG. 4 is similar to the situation where a molten resin is metered while the screw 24 moves backward in the metering step illustrated in FIG. 3.

In the capillary rheometer method, the molten resin is forced out through the capillary 72, which is a narrowed flow path, by pressure from the piston 71. In the metering step, the molten resin is forced out through the narrow flow path 68 by pressure from the screw 24. Thus, the two methods have a commonality in that a resin is forced out of a narrow flow path by applying pressure to the resin.

Though there are differences in shape and size between the piston 71 and the screw 24 and between the capillary 72 and the narrow flow path 68, the two methods are conceptually the same in the use of a narrowed flow path, which is essential for the measurement of the fluidity of a molten resin. In this embodiment, the narrow flow path 68 is assumed to be equivalent to the capillary 72.

In the metering step illustrated in FIG. 3, the width D′ of the narrow flow path 68 formed at the front end of the screw 24 is assumed to be equivalent to the diameter D of the capillary 72 of the cylinder 70 of FIG. 4. The radial length L′ of the narrow flow path 68, i.e. the thickness of the check ring 60, is assumed to be equivalent to the length L of the capillary 72.

The “flow rate of molten resin” corresponds to the amount of the metered resin per unit time. In this embodiment, the backward movement speed of the screw 24 is detected and, based on the backward movement distance per unit time of the screw 24, the diameter of the screw 24, the inner diameter of the heating barrel 22, etc., the volume between the screw 24 and the heating barrel 22 is calculated to determine the amount of the metered resin per unit time.

The back pressure applied to the screw 24 can be detected by the load cell 30.

In the metering step, the backward movement speed of the screw 24 is controlled such that the back pressure is kept constant. The backward movement speed is not constant in a strict sense;

an average speed throughout the metering step or the average of several measured speeds may be taken as the backward movement speed.

Such assumed correspondence relationships necessitate a modification of the formulae (2) and (3); an appropriate change of the coefficient may be made in advance. A value obtained from the modified formula (4) is not an absolute viscosity value strictly in accordance with the capillary rheometer method; however, the value obtained is practically sufficient as an index used to relatively assess the fluidity of a molten resin.

FIG. 5 is a block diagram of a molten resin fluidity index measuring section incorporated in a control system of the injection apparatus 10.

In FIG. 5, reference numeral 80 denotes a controller of the injection apparatus 10. The controller 80 controls the overall operation of the injection apparatus 10, and performs control of the rotating speed of the screw 24, control of the forward/backward movement speed of the screw 24, control of the injection pressure, control of the temperature of a molten resin, etc. 82 denotes a fluidity index calculation section for calculating the above-described molten resin fluidity index during a metering step. A flow rate measuring section 83 for measuring the amount of a metered resin based on the backward movement speed of the screw 24, and the load cell 30 for detecting a back pressure applied to the screw 24 are connected to the fluidity index calculation section 82. A storage section 84 stores data necessary for the calculation of the fluidity index, and also stores data on properties of the resin used, such as a fluidity index value which serves as a reference in the assessment of a molded product.

A determination section 85 reads fluidity index data from the fluidity index calculation section 82, reads reference fluidity index data from the storage section 84, and compares these data to determine whether an abnormality exists in the fluidity of a metered molten resin. The results of the determination are displayed e.g. on a monitor of a display section 86.

The operation of the above-described fluidity index measuring section will now be described in relation to successive molding operations of the injection molding machine.

As used herein, “successive molding operations” refer to a repetition of a molding cycle, including the steps of mold closing, mold clamping, metering, injection, pressure holding, mold opening, and molded product removal, performed in a successive manner over a long period of time while the nozzle of the injection apparatus is kept in touch with a mold. However, the nozzle 21 may sometimes move backward, e.g. on completion of cooling, during one cycle.

In the metering step of each molding cycle, the amount of a metered resin is measured based on the backward movement speed of the screw 24 and, in addition, the back pressure applied to the screw 24 is detected. This enables measurement of a fluidity index value by the above-described quasi-capillary rheometer method. Therefore, it becomes possible to assess, based on the measured index value, the fluidity properties of a molten resin online during successive molding operations.

Further, it also becomes possible to detect a change in the fluidity index of a molten resin during successive molding operations. For example, a situation can be detected where the fluidity index of a resin gradually increases, and the hardness of the resin increases accordingly. This makes it possible to take measures not to mold a defective product, thus contributing to stably molding a good product.

As shown in FIG. 5, the fluidity index measuring section of this embodiment includes a molding condition change command section 87. For example, when the determination section 85 determines that the fluidity index has deviated from a reference value, the molding condition change command section 87 sends a molding condition change command to the controller 80. The controller 80 then performs operations such as increasing or decreasing the rotating speed of the screw 24, changing set values of the back pressure and the resin temperature, etc. according to a preset control algorithm until the fluidity index returns to the normal range. This makes it possible to continue successive molding operations without interruption.

When changing a molding resin for a different type of resin, the completion of an operation for the resin change can be detected. In this embodiment, the storage section 84 stores reference fluidity index data on an old resin that has been used and on a new resin after the resin change, which is necessary for discrimination of the resins. The determination section 85 can detect the completion of the resin change operation by comparison of a calculated fluidity index with the reference fluidity index data on the old and new resins.

(Variation)

A molten resin fluidity index measuring method according to a variation will now be described.

While a fluidity index is calculated according to the quasi-capillary rheometer method in the above-described embodiment, it is also possible to measure a fluidity index by a quasi-MFR (melt flow rate) method during metering of a molten resin, assuming that the narrow flow path 68 is an orifice.

Referring to FIG. 4, the melt flow rate method is performed by applying a predetermined load to the piston 71 to force a fluid out of the capillary (orifice) 72, and measuring the weight of the ejected fluid per 10 minutes (g/10 min).

The metering step is performed under control so that a constant back pressure is continually applied to the screw 24; therefore, the amount of a metered resin per 10 minutes is to be calculated. The amount of a metered resin per 10 minutes can be calculated from the amount of the metered resin per unit time, determined in the above-described embodiment.

The fluidity index, measured by the quasi-MFR method, is not suited for a strict assessment of the fluidity of a molten resin, but can be used as an auxiliary index for roughly determining whether the resin is hard or soft.

In the above-described embodiments, the present invention is applied to injection molding using a thermoplastic resin as a molding material. The present invention can also be applied to injection molding using a thermosetting resin. An injection apparatus for a thermosetting resin cannot use any check ring at the front end of a screw. In the injection apparatus, a thermosetting resin flows through a narrow path separated by a flight and formed on the peripheral surface of the screw. Therefore, as in the case of a thermoplastic resin, it is possible to calculate a fluidity index in a metering step.

While preferred embodiments of the molten resin fluidity index measuring method according to the present invention have been described, these embodiments have been presented by way of example only, and are not intended to limit the scope of the present invention. Indeed, the novel apparatus, method and system described herein may be embodied in a variety of other forms; furthermore, various omissions, substitutions and changes may be made to the embodiments described above without departing from the spirit of the present invention. The accompanying claims and their equivalents are intended to cover such forms or modifications as would fall within the scope and spirit of the present invention.

1. A method for measuring a fluidity index of a molten resin in an injection molding machine which injects the molten resin in a heating barrel from a nozzle into a mold by a screw moving forward in the heating barrel, the method comprising:
assuming that a narrow flow path, formed in a flow path for the molten resin, is a capillary or an orifice in a metering step in which metered resin of the molten resin is collected in front of the screw;
measuring, with an injection apparatus of the injection molding machine, an amount of the metered resin and a back pressure applied to the screw during the metering step; and
calculating, based on the amount of the metered resin and the back pressure, a fluidity index which indicates one or more fluidity properties of the metered molten resin.

2. The molten resin fluidity index measuring method according to claim 1, wherein the narrow flow path is formed between a non-return check ring and a seat provided at the front end of the screw when the check ring is positioned away from the seat during the metering step.

3. The molten resin fluidity index measuring method according to claim 1, wherein the fluidity index is measured by a quasi-capillary rheometer method, assuming that the narrow flow path is a capillary.

4. The molten resin fluidity index measuring method according to claim 1, wherein the fluidity index is measured by a quasi-melt flow rate method, assuming that the narrow flow path is an orifice.

5. An injection molding machine for performing the fluidity index measuring method according to claim 1, comprising:
a means for measuring the amount of the metered resin during the metering step;
a means for measuring the back pressure applied to the screw during the metering step;
a calculation means for calculating the fluidity index based on the amount of the metered resin and the back pressure; and
a determination means for determining, based on the fluidity index, whether an abnormality exists in the fluidity of the molten resin.

6. The molten resin fluidity index measuring method according to claim 2, wherein the fluidity index is measured by a quasi-capillary rheometer method, assuming that the narrow flow path is a capillary.

7. The molten resin fluidity index measuring method according to claim 2, wherein the fluidity index is measured by a quasi-melt flow rate method, assuming that the narrow flow path is an orifice.

8. An injection molding machine for performing the fluidity index measuring method according to claim 2, comprising:
a means for measuring the amount of the metered resin during the metering step;
a means for measuring the back pressure applied to the screw during the metering step;
a calculation means for calculating the fluidity index based on the amount of the metered resin and the back pressure; and
a determination means for determining, based on the fluidity index, whether an abnormality exists in the fluidity of the molten resin.

9. An injection molding machine for performing the fluidity index measuring method according to claim 3, comprising:
a means for measuring the amount of the metered resin during the metering step;
a means for measuring the back pressure applied to the screw during the metering step;
a calculation means for calculating the fluidity index based on the amount of the metered resin and the back pressure; and
a determination means for determining, based on the fluidity index, whether an abnormality exists in the fluidity of the molten resin.

10. An injection molding machine for performing the fluidity index measuring method according to claim 4, comprising:
a means for measuring the amount of the metered resin during the metering step;
a means for measuring the back pressure applied to the screw during the metering step;
a calculation means for calculating the fluidity index based on the amount of the metered resin and the back pressure; and
a determination means for determining, based on the fluidity index, whether an abnormality exists in the fluidity of the molten resin.

11. An injection molding machine for performing the fluidity index measuring method according to claim 6, comprising:
a means for measuring the amount of the metered resin during the metering step;
a means for measuring the back pressure applied to the screw during the metering step;
a calculation means for calculating the fluidity index based on the amount of the metered resin and the back pressure; and
a determination means for determining, based on the fluidity index, whether an abnormality exists in the fluidity of the molten resin.

12. An injection molding machine for performing the fluidity index measuring method according to claim 7, comprising:
a means for measuring the amount of the metered resin during the metering step;
a means for measuring the back pressure applied to the screw during the metering step;
a calculation means for calculating the fluidity index based on the amount of the metered resin and the back pressure; and
a determination means for determining, based on the fluidity index, whether an abnormality exists in the fluidity of the molten resin.
